(19) United States
(12) Patent Application Publication
(10) Pub. No.: US 2004/0261593 A1
(43) Pub. Date: Dec. 30, 2004

(54) Scoll saw table insert blade positioner

(76) Inventor: Michael Edward Gallagher, Waterford, PA (US)

Correspondence Address: Michael E. Gallagher, 13651 Dorman Road, Waterford, PA, 16441, US

(21) Appl. No.: 10/609,070

(22) Filed: Jun. 28, 2003

(51) Int. Cl. B26D 1/18

(52) U.S. Cl. 83/523; 83/697

(57) ABSTRACT

A table insert blade positioner for insertion into a work table of a scroll saw having a scroll saw blade with a cutting edge and a non-cutting edge including a plate having a blade slot to permit a scroll saw blade to travel therethrough said plate insertable into the work table of the scroll saw, the plate having an upper surface and a lower surface; and a blade support structure attached to the lower surface of the plate for limiting the longitudinal motion of the scroll saw blade, wherein the blade support structure is positioned to make contact with the non-cutting edge of the scroll saw blade when sufficient pressure is exerted on the scroll saw blade in the longitudinal direction.

### CROSS-REFERENCE TO RELATED APPLICATIONS

Not Applicable.

### FIELD OF THE INVENTION

This invention relates to a table insert for a scroll saw.

### BACKGROUND OF THE INVENTION

Scroll saws are known in the art and include upper and lower arms extending forwardly from a housing. Blade clamps are disposed at the forward ends of the arms and each clamp secures one end of a generally vertically disposed blade. The blade extends through a hole in a workpiece support table. The blade is reciprocated in a generally vertical plane to achieve a precise cutting action, for example, by simultaneously reciprocating the arms in a vertical plane. Such scroll saws may be utilized to make both straight line and curved cuts in rather intricate patterns and shapes in a variety of sheet like materials including wood, metal, plastic and the like. Generally the teeth of the blade are so shaped such that the blade cuts only on the down stroke.

The scroll saw table necessarily has an aperture to allow for the blade to pass through the plane of the table. Generally the aperture is larger than necessary to allow for different blade sizes in addition to allowing for a tiltable table. In addition, the larger aperture facilitates replacing a worn or broken blade with a new one. For this reason, a table insert is generally placed over the table aperture to cover the void. A typical table insert for a commonly available scroll saw is made from plastic or metal, is circular in shape and measures approximately 2 19/32 inches in diameter and about 3/32 inches in thickness.

During the operation of the scroll saw, pressure on the workpiece tends to deform the blade. The operator pushes the workpiece into the blade. This pressure deforms the blade in the longitudinal direction. The deformation results in less cutting accuracy and the additional stress on the blade reduces blade life.

In U.S. Pat. No. 6,272,964B1, Heilshov describes a throat plate blade guide for a band saw. The blade guide prevents lateral motion of the band saw blade with two blade guide structures juxtaposed on opposite sides of the band saw blade. Longitudinal motion of the blade is limited by means of a roller thrust bearing positioned at the rear of the blade slot. The roller thrust bearing is appropriate for a band saw blade, which only travels in a single direction. However, the blade of a scroll saw reciprocates, and a roller bearing would be inappropriate and result in shorter bearing life. The band saw blade is generally far less flexible than the scroll saw blade, due to the fact that the band saw blade is generally wider and made from thicker metal. In addition, the roller thrust bearing contacts the blade some distance (at least as great as the radius of the roller thrust bearing) below the point of contact between the blade and the workpiece. Because of this distance and the high degree of flexibility of the scroll saw blade, longitudinal motion of the blade continues to be a problem. In addition, a roller thrust bearing is expensive. Therefore, the roller thrust bearing would not perform as well with the more flexible and thinner scroll saw blade.

In U.S. Pat. No. 6,463,836, Snodgrass describes a blade guide for a band saw. The blade guide includes a wheel with a circumferential groove that is in continuous contact with the non-cutting edge of the band saw blade. This blade guide had the same disadvantages as the roller thrust bearing described in the preceding paragraph, and would not perform well with the scroll saw blade.

Therefore, heretofore known scroll saws suffer from the limitation that the blade can be flexed by the workpiece resulting in a degradation of cutting accuracy and a reduction in blade life. Existing table inserts and blade guides do not adequately solve the problem.

### SUMMARY OF THE INVENTION

It is an object of the present invention to provide a table insert for a scroll saw that increases cutting accuracy and blade lifespan by preventing the longitudinal deformation of the scroll saw blade.

This object is met according to the present invention by a table insert blade positioner for insertion into a work table of a scroll saw having a scroll saw blade with a cutting edge and a non-cutting edge including a plate having a blade slot to permit a scroll saw blade to travel therethrough said plate insertable into the work table of the scroll saw, the plate having an upper surface and a lower surface; and a blade support structure attached to the lower surface of the plate for limiting the longitudinal motion of the scroll saw blade, wherein the blade support structure is positioned to make contact with the non-cutting edge of the scroll saw blade when sufficient pressure is exerted on the scroll saw blade in the longitudinal direction.

The inventive table insert blade positioner has the advantage that it effectively limits the flexing of the scroll saw blade in the longitudinal direction, increasing cutting accuracy and blade life. In addition, the inventive table insert blade positioner is inexpensive to manufacture.

### BRIEF DESCRIPTION OF THE DRAWINGS

FIG. 1 is a perspective view of a scroll saw showing the scroll saw blade, the work table, and the inventive table insert blade positioner seated within the work table aperture.

FIG. 2 is a top view of the prior art table insert.

FIG. 3 is a cross-sectional view of the prior art table insert of FIG. 2 along line 2-2 thereof.

FIG. 4 is a bottom view of the inventive table insert blade positioner.

FIG. 5 is a side view of the table insert blade positioner of FIG. 4.

FIG. 6 is a bottom view of an alternative to the inventive table insert blade positioner.

FIG. 7 is a side view of the table insert blade positioner of FIG. 6.

### DETAILED DESCRIPTION OF THE INVENTION

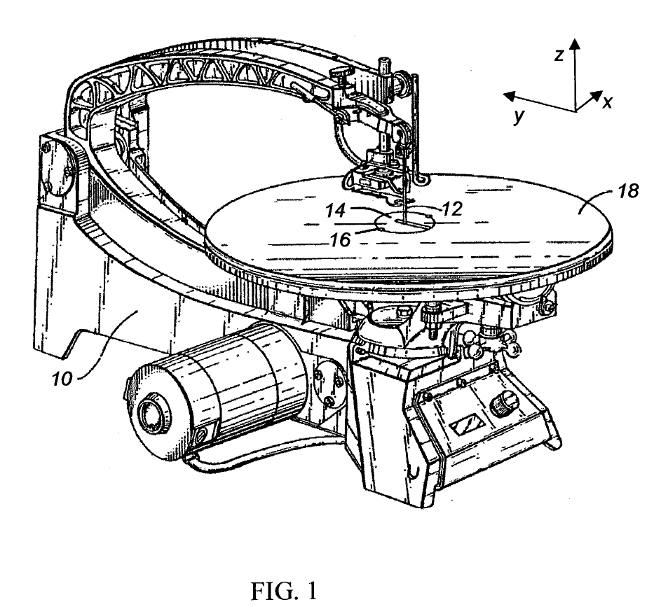

FIG. 1 shows a scroll saw machine 10 with a reciprocating scroll saw blade 12 extending through a table insert 14 and an aperture 16 disposed on a scroll saw work table 18. In operation, a workpiece is placed on the top surface of the work table 18 and pressed into the blade 12. For reference, mutually orthogonal direction vectors x, y, and z are shown. Direction x is side to side and also herein called the lateral direction. Direction y is the direction along which the workpiece is pressed into the scroll saw blade 12. This is also referred herein as the longitudinal direction. Direction z is the direction along which the scroll saw blade reciprocates (up). Direction z is vertical.

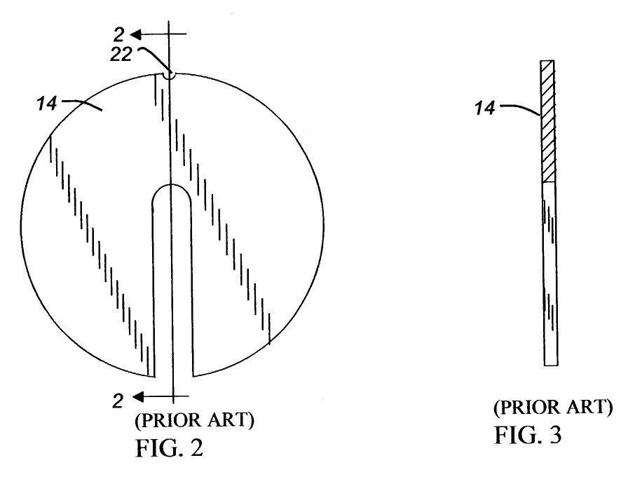

FIGS. 2 and 3 show a typical prior art table insert 14 whose sole function is to provide a passage for blade travel without any control of lateral or longitudinal blade movement. As is apparent from FIGS. 2-3, the prior art table insert 14 is not the primary means to restrain either lateral or longitudinal deformation of the scroll saw blade 12. Notch 22 fits around a tooth (not shown) within the aperture 16 of FIG. 1 to prevent the table insert 14 from slipping within the aperture 16.

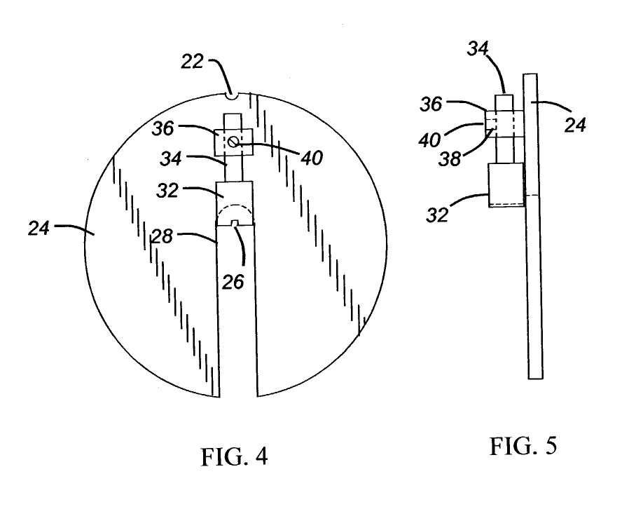

Referring to FIGS. 4 and 5, there is shown the presently preferred embodiment of an inventive table insert blade positioner 14 for insertion into an aperture 16 disposed on a scroll saw work table 18. FIG. 4 shows a bottom view of the table insert blade positioner 14. The table insert blade positioner 14 comprises a table insert 26 having a blade slot 28 sized to permit a scroll saw blade 12 to travel therethrough. Notch 22 fits around a tooth (not shown) within the aperture 16 of FIG. 1 to prevent the table insert 14 from slipping within the aperture 16.

A stop block 32 is positioned at the rear of the blade slot 28 for the purpose of preventing the longitudinal flexing of the scroll saw blade 12. The stop block as shown is attached to a shaft 34. The cylindrical shaft 34 having a principle axis slides longitudinally within the shaft guide 36, allowing the user to adjust the position forward or rearward of the stop block 32. Thus, the user can adjust the position of the stop block 32 such that it just barely contacts the non-cutting edge of the scroll saw blade 12 its most rearward position within the reciprocating stroke of the scroll saw blade 12.

Preferably the front facing plane of the stop block 32 is a square, and the axis of the cylindrical shaft 34 intersects the center of the square. The shaft guide 36 has a threaded bore 38 disposed perpendicularly to the principle axis of the shaft 34 for insertion of a countersunk set screw 40. The set screw 40 is tightened by the user to lock the position of the shaft 34 within the shaft guide 36, thereby locking the position of the stop block 32. It should be apparent to the reader that when the user places sufficient cutting pressure on the workpiece in the longitudinal direction, the non-cutting edge of the scroll saw blade 12 will be forced into contact with the stop block 32. The distance along the scroll saw blade 12 (i.e. along the z direction) between the point of contact with the workpiece (i.e. the top planar surface of the work table 18) and the stop block 32 is only the thickness of the throat plate 24. Preferably this distance is less than 0.25 inches. This small distance inhibits the flexing of the scroll saw blade 12.

The stop block 32 may be non-limitedly formed from teflon, wood, plastic, fiberglass, metal, composite or similar materials having a low coefficient of friction.

With continuous use, the non-cutting edge of the scroll saw blade 12 might eventually wear a groove 26 aligned with the scroll saw blade 12 into the stop block 32. The user can simply loosen the set screw 40, slide the shaft 34 from the shaft guide 36, rotate (preferably 90 degrees), then reinsert the shaft 34 into the shaft guide 36 and after positioning the stop block 32, tighten the set screw 40. Such an operation increases the life of the stop block 32.

Preferably the stop block 32 is a prism or a cylinder in shape. A prism is a three dimensional shape having two congruent, parallel bases that are polygons. While the stop block 32 described in FIG. 5 preferably has a front facing plane that is a square, many other shapes will work well. In an example alternative, the front facing plane of the stop block is a circle such that the axis of the shaft 34 intersects the center of the circle. Then, when the non-cutting edge of the scroll saw blade 12 wears an excessively deep groove into the stop block 32, the shaft 34 may be rotated about the axis of the shaft 34 a small amount so that the excessively deep groove will not align with the scroll saw blade 12.

A slight groove 26 in the stop block 32 aligned with the scroll saw blade 12 actually can improve the performance of the table insert blade positioner 14 by limiting flexing of the scroll saw blade 12 in the lateral direction (in addition to the longitudinal direction as already described).

The stop block 32 shown in FIG. 5 is adjustable in the longitudinal direction (y direction) by means of an assembly including the shaft 34, shaft guide 36 with hole 38 for a set screw 40. Those skilled in the art will recognize that alternatively, a second such assembly will additionally provide adjustability of the stop block 32 in the lateral direction (x direction).

The stop block 32 and the means for adjustment (shaft 34, shaft guide 36, and set screw 40) comprise a blade support structure. As shown in FIGS. 4 and 5, the blade support structure is attached to the lower surface of the throat plate 24.

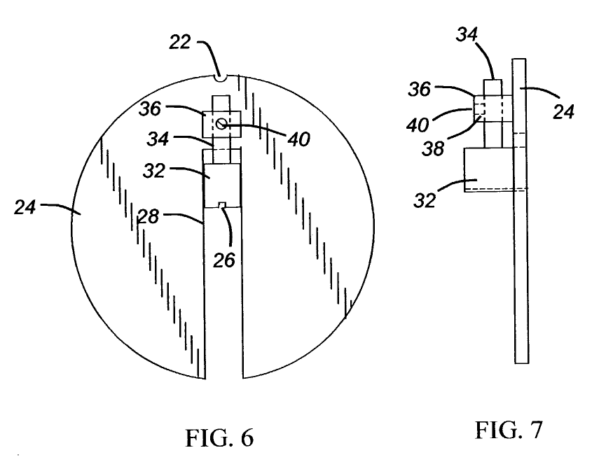

FIGS. 6-7, an alternative table insert blade positioner 14 is shown. This alternative table insert blade positioner 14 has the advantage that the top surface of the stop block 32 is flush with the top surface of the work table 18 (and also is flush with the table insert 24). This reduces the distance along the scroll saw blade 12 (i.e. along the z direction) between the point of contact with the workpiece the stop block 32 to nil, thereby providing maximum limitation on the flexing of the scroll saw blade 12.

FIG. 6 shows the blade slot 28 is large enough to accommodate both the scroll saw blade 12 and the stop block 32. FIG. 7 shows a side view of the alternative table insert blade positioner 14. The stop block 32 extends through the table insert 24.

As is apparent from the above embodiment, the table insert blade positioner 14 resolves many of the deficiencies in the prior art. In particular, the table insert blade positioner 14 of the present invention will be disposed within the plane of the scroll saw work table 18 in close proximity to the workpiece. The table insert blade positioner 14 is inexpensive to manufacture, and provides excellent limitation of the unintended flexing of the blade in both the lateral and the longitudinal directions.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

### PARTS LIST

10 scroll saw

12 scroll saw blade

14 table insert blade positioner

16 aperture

18 work table

22 notch

24 throat plate

26 groove

28 1 blade slot

32 stop block

34 shaft

36 shaft guide

38 hole

40 set screw

1. A table insert blade positioner for insertion into a work table of a scroll saw having a scroll saw blade with a cutting edge and a non-cutting edge comprising:
a) a plate having a blade slot to permit a scroll saw blade to travel therethrough said plate insertable into the work table of the scroll saw, the plate having an upper surface and a lower surface; and
b) a blade support structure attached to the lower surface of the plate for limiting the longitudinal motion of the scroll saw blade, wherein the blade support structure comprises a stop block having a front facing plane, said front facing plane positioned to make contact with the non-cutting edge of the scroll saw blade when sufficient pressure is exerted on the scroll saw blade in the longitudinal direction.

2. The table insert blade positioner as claimed in claim 1, wherein the stop block is a prism.

3. The table insert blade positioner as claimed in claim 2, wherein the stop block has a groove aligned with the scroll saw blade.

4. The table insert blade positioner as claimed in claim 1, wherein the blade support structure comprises means for adjusting the longitudinal position of the blade support structure.

5. The table insert blade positioner as claimed in claim 4, wherein the stop block is a prism.

6. The table insert blade positioner as claimed in claim 4, wherein the longitudinal position of the blade support structure is locked with a set screw.

7. The table insert blade positioner as claimed in claim 1, wherein the top of the stop block is flush with the surface of the work table.

8. A scroll saw having a work table and a scroll saw blade having a cutting edge and a non-cutting edge comprising a blade support structure for limiting the longitudinal motion of the scroll saw blade, wherein the blade support structure comprises a stop block having the shape of a prism, wherein the stop block is positioned to make contact with the non-cutting edge of the scroll saw blade when sufficient pressure is exerted on the scroll saw blade in the longitudinal direction, and wherein the stop block does not rotate when contacted with the non-cutting edge of the blade.

9. The scroll saw claimed in claim 8, wherein the position of the stop block is adjustable in the longitudinal direction.

10. The scroll saw as claimed in claim 9, wherein the top of the stop block is flush with the top surface of the work table.

11. The table insert blade positioner as claimed in claim 1, wherein the stop block does not rotate when contacted with the non-cutting edge of the blade.
